(19) United States
(12) Patent Application Publication
(10) Pub. No.: US 2009/0283441 A1
(43) Pub. Date: Nov. 19, 2009

(54) Cosmetics kit

(76) Inventors: Peter Santaw, Pasadena, CA (US); Helena Lam, Thousand Oaks, CA (US); Katherine Benecke, Los Angeles, CA (US); Aj Newton, Woodland Hills, CA (US)

Correspondence Address: TOPE-MCKAY & ASSOCIATES, 23852 PACIFIC COAST HIGHWAY #311, MALIBU, CA, 90265, US

(21) Appl. No.: 12/154,144

(22) Filed: May 19, 2008

(51) Int. Cl. B65D 69/00; B05B 17/00; B05B 17/08

(52) U.S. Cl. 206/581; 239/1; 239/23; 239/17; 239/289

(57) ABSTRACT

A cosmetics kit including a fountain is described. The cosmetics kit comprises a base with a fountain attached for circulating a fluid and at least one cosmetic connectable with the base. Additionally, a mixing bowl connectable with the base is included to allow the user to mix custom cosmetics such as lip gloss and perfume with mixing accessories included with the cosmetics kit. Furthermore, a scented oil is added to the circulating fluid in the fountain to create an aromatherapy experience.

### BACKGROUND OF THE INVENTION

(1) Field of Invention

The present invention relates to a children's cosmetics kit and, more particularly, to a children's cosmetics kit including a fountain.

(2) Description of Related Art

Children's cosmetics kits have long been known in the art. Such kits typically contain cosmetics, including nail polish and make-up to be used by the child to simulate a beauty experience similar to an adult's.

Although cosmetics kits as described above are widely available, these kits lack elements which provide a relaxing sensory experience such as that found in a beauty spa. As spas have gained popularity, many women now enjoy including their daughters in the experience to promote bonding and encourage a positive self image. Spas generally provide a variety of treatments such as facial masks, body scrubs, and aromatherapy treatments.

Furthermore, typical cosmetics kits include beauty products which are already made. A cosmetics kit which would allow users to create the beauty products themselves would add a new dimension of play to the kit. The user could mix up the desired make-up or spa treatments then apply them to either herself or her friends to simulate a real spa experience.

Thus, a continuing need exists for a children's cosmetics kit which simulates a beauty spa experience.

### SUMMARY OF THE INVENTION

The present invention relates to a kit for cosmetics. The cosmetics kit comprises a base, a fountain attached with the base for circulating a fluid, and at least one cosmetic connectable with the base.

In another aspect, the fountain is an aromatherapy fountain.

In another aspect, the at least one cosmetic is a lip gloss, perfume, mask, scrub, or scented oil.

In another aspect, the fountain comprises at least one basin.

In yet another aspect, the present invention further comprises a mixing bowl connectable with the base.

Additionally, the present invention further comprises at least one cosmetic mixing accessory.

In yet another aspect, the cosmetic mixing accessory is a spoon whisk, pipette, or funnel.

In another aspect, the base is comprised of a top section and a bottom section.

In yet another aspect, the present invention further comprises a pump in connection with the at least one basin.

Finally, in another aspect, the pump is attached with the base.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a front-view illustration of a cosmetics kit according to the present invention;

FIG. 2 is a top-view illustration of a cosmetics kit according to the present invention;

FIG. 3 is a bottom-view illustration of a cosmetics kit according to the present invention;

FIG. 4 is a rear-view illustration of a cosmetics kit according to the present invention;

FIG. 5 is a right, side-view illustration of a cosmetics kit according to the present invention;

FIG. 6 is a left, side-view illustration of a cosmetics kit according to the present invention;

FIG. 7 is a front, exploded-view illustration of a cosmetics kit, showing a top section and bottom section of a base;

FIG. 8 is a rear, exploded-view illustration of a cosmetics kit, showing the top section and bottom section of the base;

FIG. 9 is a bottom-view illustration of a top section of the base of a cosmetics kit according to the present invention;

FIG. 10 is a sectional-view illustration of a cosmetics kit according to the present invention; and

FIG. 11 is an alternate sectional-view illustration of a cosmetics kit according to the present invention.

### DETAILED DESCRIPTION

The present invention relates to a children's cosmetics kit and, more particularly, to a children's cosmetics kit including a fountain. The following description is presented to enable one of ordinary skill in the art to make and use the invention and to incorporate it in the context of particular applications. Various modifications, as well as a variety of uses, in different applications will be readily apparent to those skilled in the art, and the general principles defined herein may be applied to a wide range of embodiments. Thus, the present invention is not intended to be limited to the embodiments presented, but is to be accorded with the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter-clockwise have been used for convenience purposes only and are not intended to imply any particular fixed direction. Instead, they are used to reflect relative locations and/or directions between various portions of an object. As such, as the present invention is changed, the above labels may change their orientation.

(1) Description

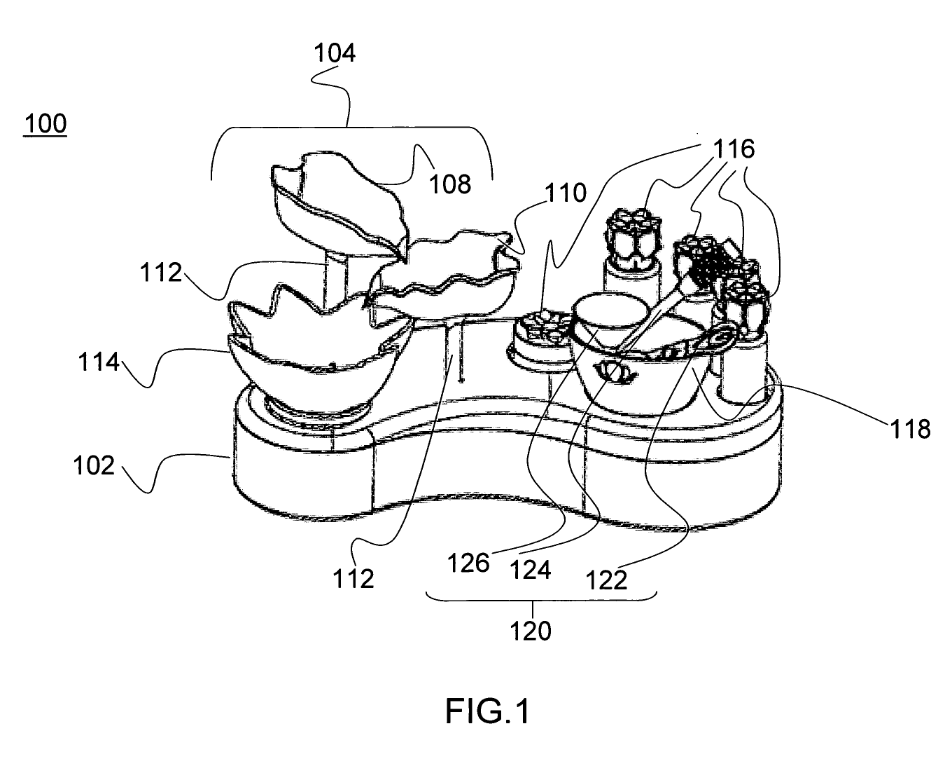

The present invention relates to a children's cosmetics kit including a fountain. FIG. 1 depicts a front-view illustration of a cosmetics kit 100 according to the present invention. The cosmetics kit 100 includes a base 102 formed in a suitable shape for arranging various components thereon. The base 102 is constructed of any suitable durable material, a non-limiting example of which includes plastic. A fountain 104 is attached with the base for circulating a fluid. The fountain 104 comprises at least one basin (e.g., top basin 108) for a fluid to flow therethrough. The at least one basin (e.g., top basin 108) is formed in any suitable shape to allow a fluid to both collect and flow from it, non-limiting examples of which include concave-shaped leaves or flowers.

In a desired aspect, the fountain 104 comprises a plurality of basins arranged at different levels to allow a fluid to flow downward from one basin to the next. The plurality of basins can be connected with the base using any suitable technique. As a non-limiting example and as shown in FIG. 1, the top basin 108 and a middle basin 110 are attached with the base 102 with an elongated member 112 which extends from the base 102, while a bottom basin 114 is directly attached with the base 102. Although a top basin 108, middle basin 110, and bottom basin 114 are depicted, one skilled in the art can appreciate that the present invention is not intended to be limited thereto and that any suitable number of basins can be utilized with the present invention.

Additionally, the cosmetics kit 100 includes at least one cosmetic 116 which is connectable with the base 102. The cosmetic 116 may be any type of cosmetic item, non-limiting examples of which include a lip gloss, perfume, mask, scrub, or scented oil. The cosmetic 116 may also be a cosmetic component such as a lip gloss or perfume base, or a flavored liquid.

Furthermore, a mixing bowl 118 is connectable (i.e., fixed or detachably attachable) with the base 102 of the cosmetics kit 100. The mixing bowl 118 is provided to allow the user to mix their own custom cosmetic with the included mixing accessories 120. The mixing accessories 120 are any suitable accessories that are formed to assist a user in making and mixing the cosmetics, non-limiting examples of which include a spoon 122, a pipette 124, and a funnel 126.

A desired use of the cosmetics kit 100 is to create a custom cosmetic by adding flavors or scents to a cosmetic base (i.e., lip gloss base, perfume base) and mixing them in the mixing bowl 118 using the mixing accessories 120. The custom cosmetic can then be placed in a bottle (not shown) and stored for later use. Additionally, the fountain is an aromatherapy fountain so that a cosmetic 116, desirably scented oil, can be added to the fluid to create a pleasing custom aroma and provide a spa-like atmosphere.

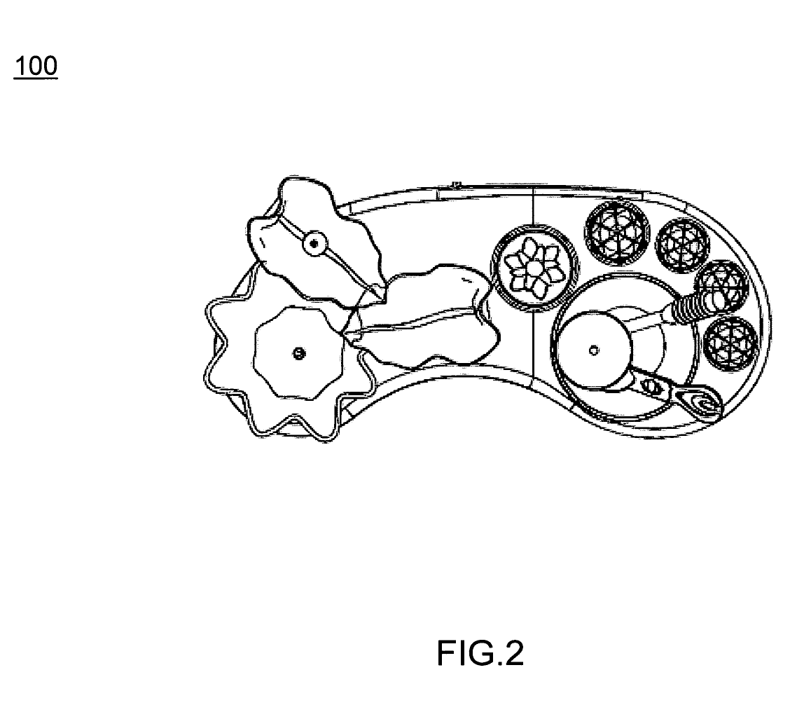

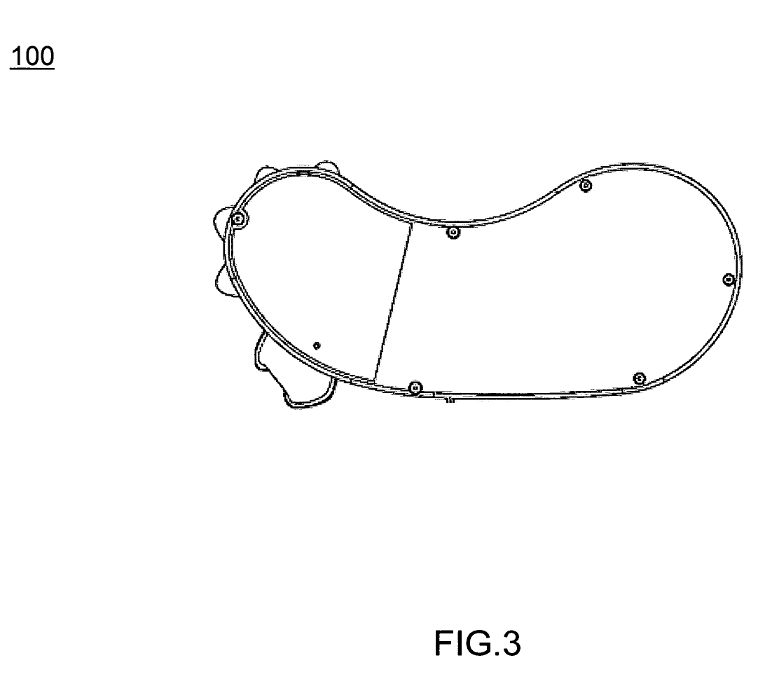

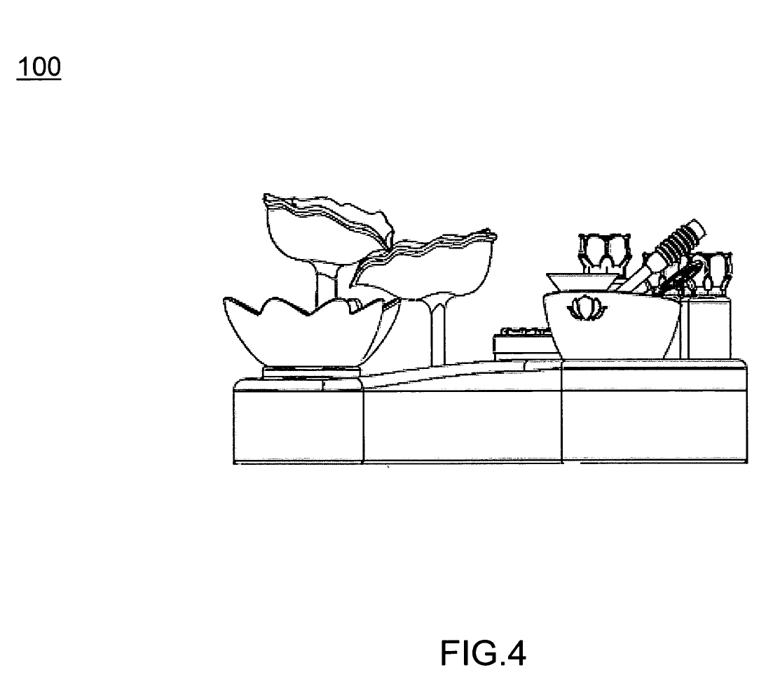

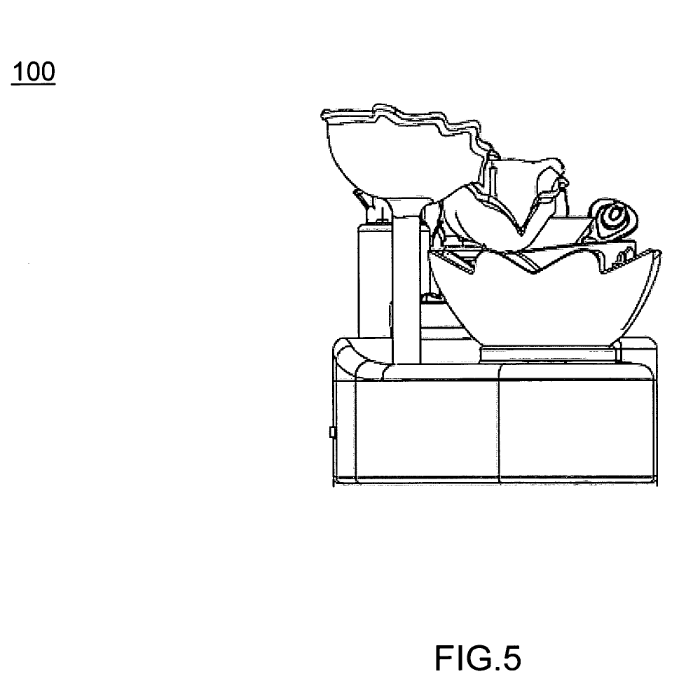

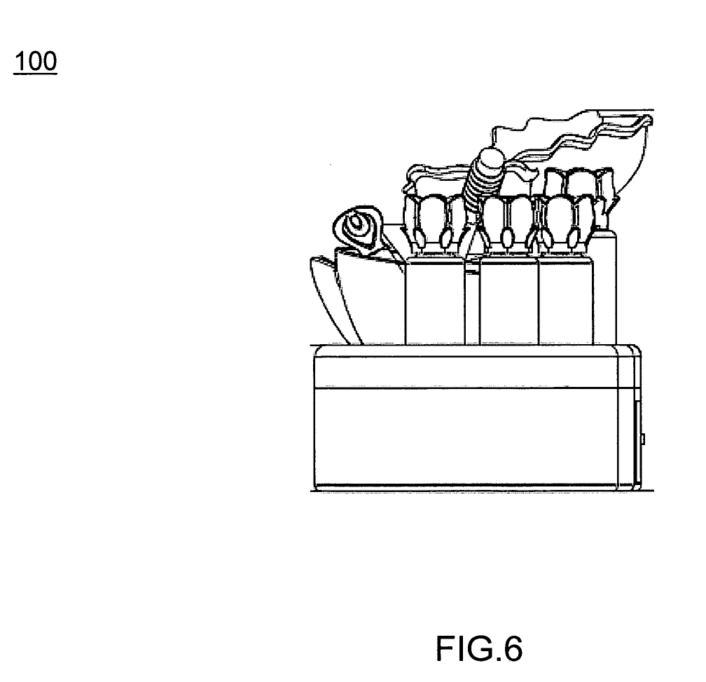

FIGS. 2-6 illustrate various views of a cosmetics kit 100 according to the present invention, including the elements as described above for FIG. 1. More specifically, FIG. 2 is a top-view; FIG. 3 is a bottom-view; FIG. 4 is a rear-view; FIG. 5 is a right, side-view; and FIG. 6 is a left, side-view.

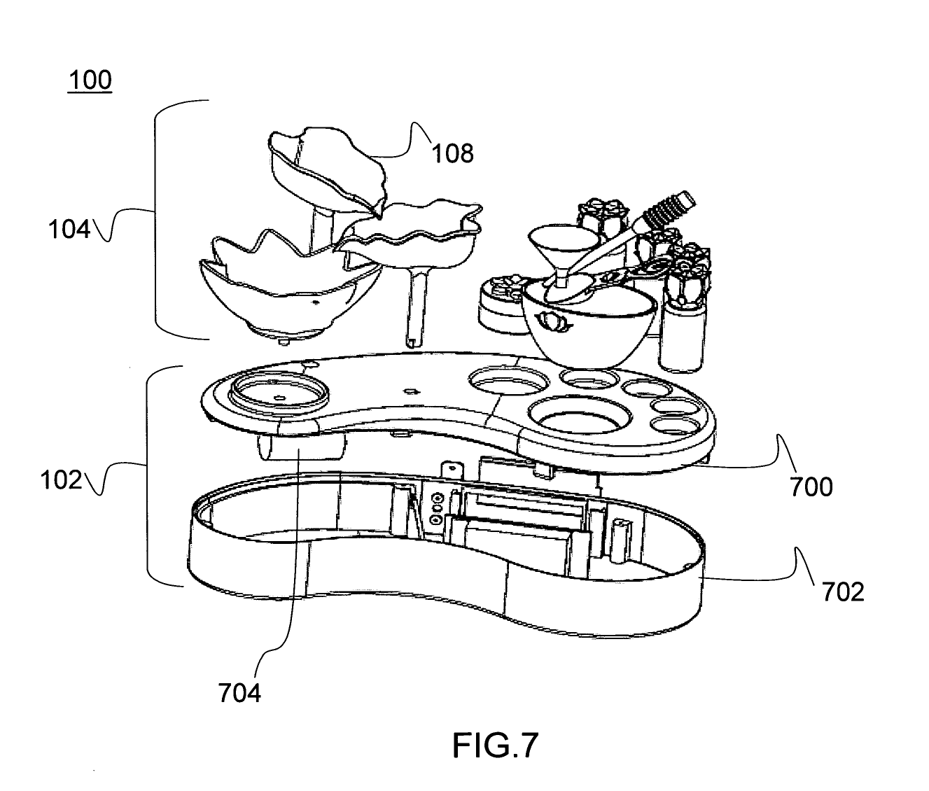

FIG. 7 illustrates a front, exploded-view of the cosmetics kit 100, showing the base 102 comprised of a top section 700 and a bottom section 702. In addition, a pump 704 is displayed which functions to pump a fluid into the at least one basin (e.g., top basin 108) of the fountain 104. The pump 704 is attached with the base 102 in any suitable location, but is desirably attached with the top section 700 of the base 102.

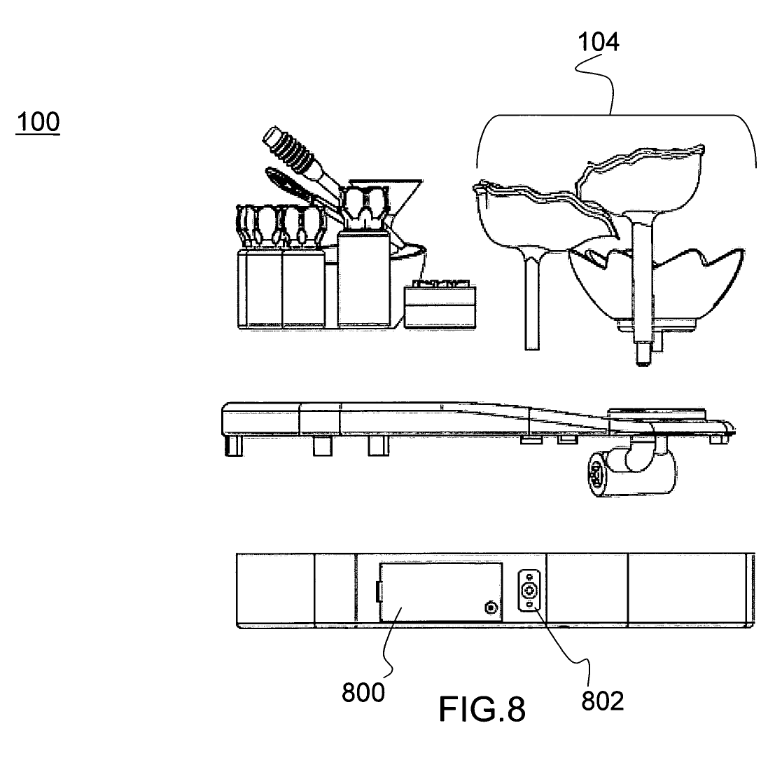

FIG. 8 illustrates a rear, exploded-view of the cosmetics kit 100, showing the elements described above with respect to FIG. 7. In addition, a battery housing cover 800 and on/off switch 802 are shown. While illustrated as using a battery, one skilled in the art can appreciate that the fountain 104 can be powered through any suitable technique, non-limiting examples of which include an AC/DC electrical cord, solar power, and battery power.

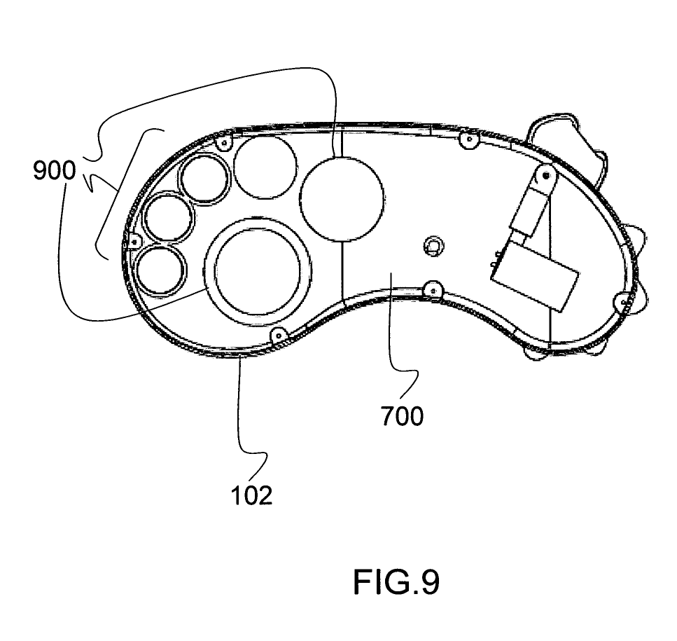

FIG. 9 illustrates a bottom-view of the top section 700 of the base 102, showing a plurality of grooves 900 used to stabilize the at least one cosmetic, the top basin, and the mixing bowl. The grooves 900 may be any suitable shape to hold the aforementioned elements, a non-limiting example of which is a circular shape, as shown.

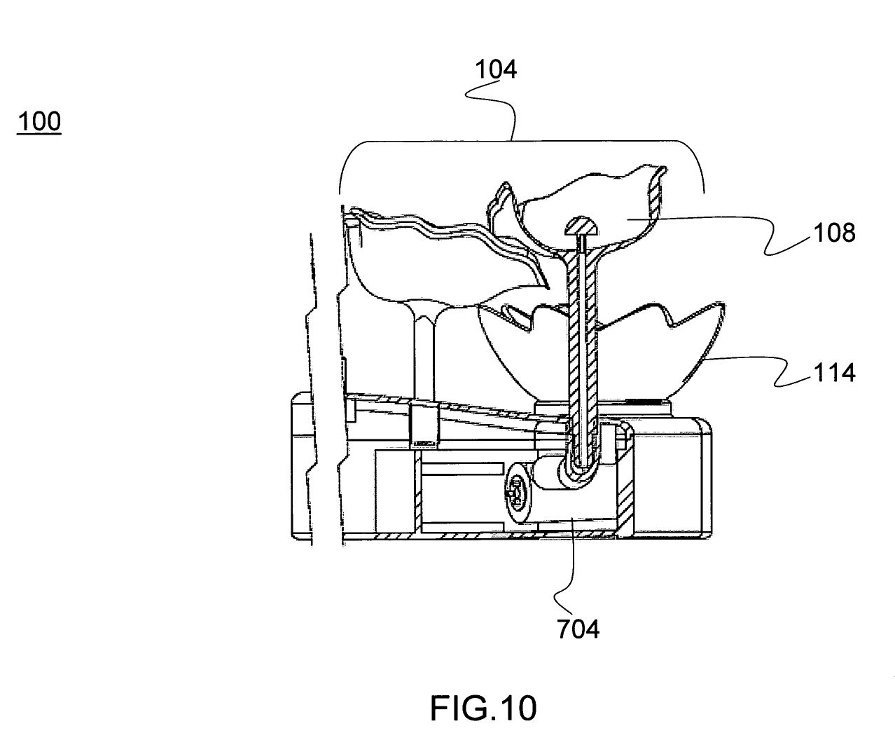

FIG. 10 illustrates a sectional view of the cosmetics kit 100, showing the pump 704 in connection with the bottom basin 114 and top basin 108 of the fountain 104.

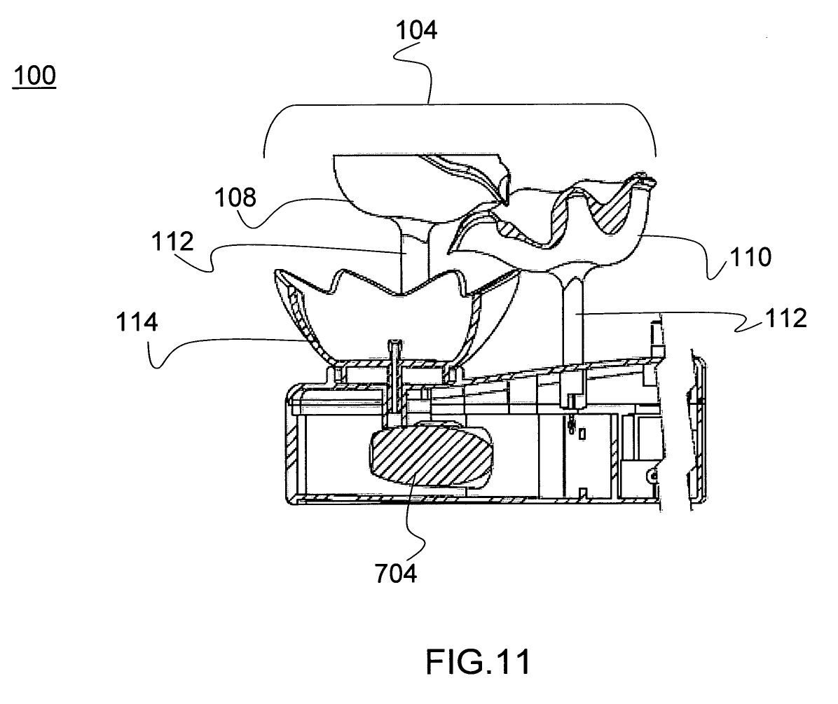

FIG. 11 illustrates an alternate sectional view of the cosmetics kit 100, further demonstrating that the pump 704 is in connection with the bottom basin 114 of the fountain 104. As shown in FIG. 10, in a preferred aspect, these connections allow a fluid to flow from the pump 704 through the elongated member 112 to the top basin 108 of the fountain 104 and then down to the middle basin 110. Finally, the fluid flows down to the bottom basin 114 where it then returns to the pump 704, as shown in the connection between the bottom basin 114 and the pump 704 in FIG. 11.

What is claimed is:

1. A kit for cosmetics, comprising:
a base;
a fountain attached with the base for circulating a fluid; and
at least one cosmetic connectable with the base.

2. A kit for cosmetics as set forth in claim 1, wherein the at least one cosmetic is selected from the group consisting of a lip gloss, perfume, mask, scrub, and scented oil.

3. A kit for cosmetics as set forth in claim 2, wherein the fountain comprises at least one basin for a fluid to flow therethrough.

4. A kit for cosmetics as set forth in claim 3, further comprising a mixing bowl connectable with the base.

5. A kit for cosmetics as set forth in claim 4, further comprising at least one cosmetic mixing accessory.

6. A kit for cosmetics as set forth in claim 5, wherein the at least one cosmetic mixing accessory is selected from the group consisting of a spoon, pipette, and funnel.

7. A kit for cosmetics as set forth in claim 6, wherein the base is comprised of a top section and a bottom section.

8. A kit for cosmetics as set forth in claim 7, further comprising a pump in connection with the at least one basin.

9. A kit for cosmetics as set forth in claim 8, wherein the pump is attached with the base.

10. A kit for cosmetics as set forth in claim 1, wherein the at least one cosmetic is selected from the group consisting of a lip gloss, perfume, mask, scrub, and scented oil.

11. A kit for cosmetics as set forth in claim 1, wherein the fountain comprises at least one basin for a fluid to flow therethrough.

12. A kit for cosmetics as set forth in claim 1, further comprising a mixing bowl connectable with the base.

13. A kit for cosmetics as set forth in claim 1, further comprising at least one cosmetic mixing accessory.

14. A kit for cosmetics as set forth in claim 13, wherein the at least one cosmetic mixing accessory is selected from the group consisting of a spoon, pipette, and funnel.

15. A kit for cosmetics as set forth in claim 1, wherein the base is comprised of a top section and a bottom section.

16. A kit for cosmetics as set forth in claim 11, further comprising a pump in connection with the at least one basin.

17. A kit for cosmetics as set forth in claim 16, wherein the pump is attached with the base.

18. A method for forming a kit for cosmetics, comprising acts of:
forming a base;
forming a fountain attached with the base with at least one basin for circulating a fluid;
connecting a pump with the at least one basin, whereby the pump acts to pump a fluid into the at least one basin;
connecting at least one cosmetic with the base;
connecting a mixing bowl with the base; and
forming at least one cosmetic mixing accessory.

19. A method for forming a kit for cosmetics as set forth in claim 18, wherein the at least one cosmetic is selected from the group consisting of a lip gloss, perfume, mask, scrub, and scented oil.

20. A method for using a kit for cosmetics as set forth in claim 19, comprising acts of:
Mixing at least two of the at least one cosmetics in the mixing bowl with the at least one cosmetic mixing accessory to create a custom cosmetic;
Adding a scented oil to the circulating fluid in the fountain to create a custom aroma.
